(19) United States
(12) Patent Application Publication
(10) Pub. No.: US 2011/0178832 A1
(43) Pub. Date: Jul. 21, 2011

(54) PREREQUISITE-DRIVEN MEETING SCHEDULING

(75) Inventors: Joshua D. Burchard, Westford, MA (US); Michael J. Forte, Poughkeepsie, NY (US); Zamir G. Gonzalez, Poughkeepsie, NY (US); Jenny S. Li, Poughkeepsie, NY (US)

(73) Assignee: INTERNATIONAL BUSINESS MACHINES CORPORATION, Armonk, NY (US)

(21) Appl. No.: 12/689,419

(22) Filed: Jan. 19, 2010

(51) Int. Cl. G06Q 10/00

(52) U.S. Cl. 705/7.12; 705/301

(57) ABSTRACT

A method, system and computer program product for prerequisite-driven meeting scheduling are provided. The method includes defining prerequisites to be met prior to confirming scheduling of a meeting, and defining a threshold to confirm scheduling of the meeting based on prerequisites completed. The method also includes tracking the prerequisites completed prior to the meeting, the tracking performed by tracking logic of a scheduling tool executing on a host system. The method further includes confirming that the meeting will be held as scheduled in response to determining that the prerequisites completed meet the threshold. The method additionally includes rescheduling the meeting in response to determining that the prerequisites completed are below the threshold, the rescheduling performed by the scheduling tool executing on the host system.

### BACKGROUND

The present invention relates generally to computer-based meeting scheduling, and more specifically, to prerequisite-driven meeting scheduling.

Meetings are often scheduled with the goal of discussing or reviewing work products, events, and/or to share information. In order for a meeting to be productive, preparation or certain action tasks may be needed prior to the meeting. For example, meeting participants should have reviewed materials prior to the meeting, and a responsible party should have sent the materials for review to potential attendees prior to the meeting and early enough to provide sufficient time for review. There may be situations when prerequisites of a meeting are not met, resulting in an inefficient meeting if the meeting is held as scheduled.

The process of preparing for a meeting typically requires a meeting chair to perform numerous manual steps, such as manually checking the status of prerequisites of the meeting prior to the meeting, communicating with people who are responsible for fulfilling the prerequisites, following up with people who do not complete their action items as requested, and notifying all the meeting participants that the meeting needs to be rescheduled if the prerequisites are not fulfilled. The meeting chair may also repeat this manual process for the rescheduled meeting as well.

### SUMMARY

An exemplary embodiment is a method for prerequisite-driven meeting scheduling. The method includes defining prerequisites to be met prior to confirming scheduling of a meeting, and defining a threshold to confirm scheduling of the meeting based on prerequisites completed. The method also includes tracking the prerequisites completed prior to the meeting, the tracking performed by tracking logic of a scheduling tool executing on a host system. The method further includes confirming that the meeting will be held as scheduled in response to determining that the prerequisites completed meet the threshold. The method additionally includes rescheduling the meeting in response to determining that the prerequisites completed are below the threshold, the rescheduling performed by the scheduling tool executing on the host system.

Another exemplary embodiment is a system for prerequisite-driven meeting scheduling including a scheduling database and a host system in communication with the scheduling database. The host system is configured to define prerequisites to be met prior to confirming scheduling of a meeting, and store the prerequisites in the scheduling database. The host system is further configured to define a threshold to confirm scheduling of the meeting based on prerequisites completed, and track the prerequisites completed prior to the meeting. The host system is also configured to confirm that the meeting will be held as scheduled in response to determining that the prerequisites completed meet the threshold, and reschedule the meeting in response to determining that the prerequisites completed are below the threshold.

A further exemplary embodiment is a computer program product for prerequisite-driven meeting scheduling; the computer program product includes a computer readable storage medium readable by a processing circuit and storing instructions for execution by the processing circuit for implementing a method. The method includes defining prerequisites to be met prior to confirming scheduling of a meeting, and defining a threshold to confirm scheduling of the meeting based on prerequisites completed. The method also includes tracking the prerequisites completed prior to the meeting. The method additionally includes confirming that the meeting will be held as scheduled in response to determining that the prerequisites completed meet the threshold, and rescheduling the meeting in response to determining that the prerequisites completed are below the threshold.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts an example of a system for prerequisite-driven meeting scheduling in accordance with exemplary embodiments;

FIG. 2 depicts an example of a workflow created in accordance with exemplary embodiments; and

FIG. 3 depicts an exemplary process for prerequisite-driven meeting scheduling in accordance with exemplary embodiments.

The detailed description explains the preferred embodiments of the invention, together with advantages and features, by way of example with reference to the drawings.

### DETAILED DESCRIPTION

Exemplary embodiments of the present invention provide prerequisite-driven meeting scheduling. A scheduling tool providing prerequisite-driven meeting scheduling enables users to create a list of prerequisites for a meeting. Prerequisites can be action items or preconditions that need to be satisfied before the meeting is confirmed. The prerequisites are assigned to responsible parties to perform actions by due dates and define the substance of the actions. Examples of prerequisite action items include, “User1 to send proposal to all meeting participants one week prior to the meeting”, or “User2 to schedule a web conference prior to the meeting”. The scheduling tool automatically tracks the status of the action items prior to the meeting using tracking logic. Automatic notifications can be sent to the responsible parties as reminders that their action item due dates are approaching, and also remind them that failure to comply may result in the meeting being canceled. If a critical action item is not completed by its associated due date and/or fewer than a threshold amount of prerequisites are completed, the meeting can be cancelled automatically, and may automatically be rescheduled. The scheduling tool may also adjust resource reservations for the meeting responsive to cancellation or rescheduling determinations.

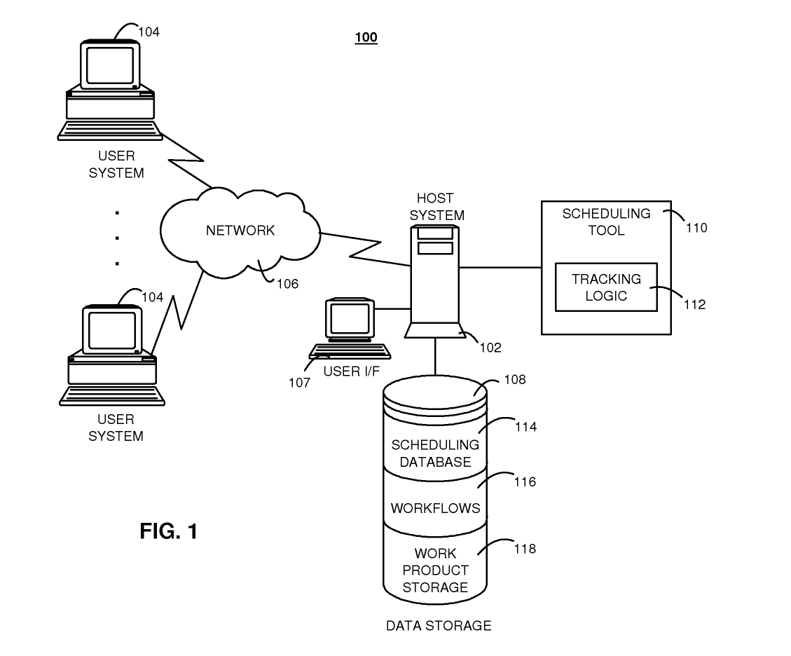

Turning now to the drawings, it will be seen that in FIG. 1 there is a block diagram of a system 100 upon which prerequisite-driven meeting scheduling is implemented in exemplary embodiments. The system 100 of FIG. 1 includes host system 102 in communication with user systems 104 over a network 106. In exemplary embodiments, the host system 102 is a high-speed processing device (e.g., a mainframe computer, a desktop computer, a laptop computer, a hand-held device, an embedded computing device, or the like) including at least one processing circuit (e.g., a CPU) capable of reading and executing instructions, and handling numerous interaction requests from the user systems 104.

In exemplary embodiments, the user systems 104 comprise desktop, laptop, general-purpose computer devices, and/or networked devices with processing circuits and I/O interfaces, such as a keyboard and display device. The host system 102 and user systems 104 can include various computer hardware and software technology known in the art, such as one or more processing units or circuits, volatile and non-volatile memory including removable media, power supplies, network interfaces, support circuitry, operating systems, and the like. The host system 102 may also include one or more user interfaces 107 with user accessible I/O devices, such as a keyboard, mouse, and display. The one or more user interfaces 107 enable one or more local users to access the host system 102 without communicating over the network 106. For example, the network 106 and user systems 104 can be omitted, where user interaction is performed through the one or more user interfaces 107.

The network 106 may be any type of communications network known in the art. For example, the network 106 may be an intranet, extranet, or an internetwork, such as the Internet, or a combination thereof. The network 106 can include wireless, wired, and/or fiber optic links. Additional computer systems (not depicted) may also access the host system 102 via the network 106 or other networks.

The data storage system 108 refers to any type of computer readable storage media and may comprise one or more secondary storage elements, e.g., hard disk drive (HDD), tape, or a storage subsystem that is internal or external to the host system 102. Types of data that may be stored in the data storage system 108 include, for example, various files and databases subject to security constraints. It will be understood that the data storage system 108 shown in FIG. 1 is provided for purposes of simplification and ease of explanation and is not to be construed as limiting in scope. To the contrary, there may be multiple data storage systems 108 utilized by the host system 102, which can be distributed in various locations of the system 100.

The host system 102 can be an e-mail server or communications server configured to execute scheduling tool 110 with tracking logic 112. In exemplary embodiments, the scheduling tool 110 accesses a scheduling database 114 on data storage system 108 in support of meeting scheduling between multiple parties. A meeting chairperson (chair) and meeting invitees can interact with the scheduling tool 110 via user systems 104 and/or user interface 107. As part of a meeting scheduling process, the scheduling tool 110 establishes a list of prerequisites in the scheduling database 114, where the prerequisites are to be completed before a meeting is held. The prerequisites may be action items or conditions that can be tracked by the tracking logic 112. Users can define one or more critical prerequisites that must be satisfied in order for the meeting to be worthwhile to hold. For instance, if the purpose of a meeting is to discuss a proposal, sending the proposal to meeting invitees at least a week ahead of time may be considered a critical prerequisite to provide adequate review time prior to the meeting. If the critical prerequisite is not met, the meeting may not be productive, so the scheduling tool 110 can cancel and reschedule the meeting.

The tracking logic 112 automatically tracks the status of action items in the scheduling database 114 and progress through workflows 116 before a meeting to ensure that prerequisites are sufficiently satisfied prior to the meeting. Workflows 116 can define actions and sequences to be performed by parties that impact whether meetings are confirmed or cancelled. The tracking logic 112 can trigger reminders to parties responsible for prerequisites at specified intervals or in response to events, such as within a threshold time of a deadline. Reminders can be sent to the prerequisite owner if the prerequisite is not fulfilled as planned. For example, a reminder can include a list of responsible parties, a due date to complete the action, and details of the action to be completed. Reminders can also be sent to additional parties other than the responsible parties to motivate the responsible parties to avoid being identified as a person who caused the meeting to be rescheduled.

In one embodiment, the meeting chair defines the meeting prerequisites to be satisfied prior to the meeting. The critical prerequisites that are defined must be satisfied; otherwise, the meeting chair will be notified that the meeting will be rescheduled by at minimum number of days. If all prerequisites are fulfilled, then a meeting confirmation will be sent.

In another embodiment, each meeting invitee can contribute to the meeting prerequisites to be satisfied in the scheduling database 114. There can be an optional time window, for instance, two days after the meeting is scheduled, to allow each meeting invitee and the meeting chair to add meeting prerequisites to the meeting.

Tables 1 and 2 illustrate examples of the type of information used to schedule meetings, establish prerequisites, configure actions, and track status, which may be included in the scheduling database 114. Table 1 includes meeting scheduling parameters that can be populated by the meeting chair or on behalf of the meeting chair and invitees. The example provided in table 1 includes a meeting identifier, a target date for the meeting, identification of the meeting chair, other meeting invitees, resources required for the meeting, a threshold to confirm the meeting, actions to be performed when noncompliant (i.e., the threshold to confirm is not met), and confirmation status. The threshold to confirm in table 1 refers to the completion status of prerequisites of the meeting as defined in table 2. The threshold to confirm can be defined as a number of prerequisites or a percentage of prerequisites completed. Additional data can also be included as part of the meeting scheduling parameters. For example, the meeting scheduling parameters of table 1 can also include a configurable limit on the number of times that a meeting is automatically rescheduled.

TABLE 1
Meeting Scheduling Parameters

| Mtg | Target | | | | Threshold | Actions when | |
|---|---|---|---|---|---|---|---|
| ID | Date | Chair | Invitees | Resources | to Confirm | Noncompliant | Confirmed |
| 0123 | Feb. | User1 | User2 | Conference | 75% | Notify Chair | No |
| | 1, 2010 | | User3 | Room; | | and auto- | |
| | | | User4 | Projector; | | reschedule | |
| | | | | Video link | | | |

TABLE 2
Prerequisites Table

| Prereq | Prerequisite | Prerequisite | Tracking | | Resched | | |
|---|---|---|---|---|---|---|---|
| ID | Description | Due | Mechanism | Critical | min | Depend | Complete |
| 0123_pre1 | User1 to send | One week | Notify | Yes | 5 days | None | No |
| | a proposal to | prior to the | User1 to | | | | |
| | everyone on | meeting | confirm | | | | |
| | the meeting | | | | | | |
| | invitation | | | | | | |
| 0123_pre2 | User1 to | 1 day before | Notify | No | 1 day | None | No |
| | create an | the meeting | User1 to | | | | |
| | electronic | | confirm | | | | |
| | meeting | | | | | | |
| | session and | | | | | | |
| | send each | | | | | | |
| | meeting | | | | | | |
| | invitee a link | | | | | | |
| 0123_pre3 | Every | 1 day before | Notify every | Yes | 1 day | 0123_pre1 | No |
| | meeting | the meeting | meeting | | | | |
| | invitee to | | invitee to | | | | |
| | review the | | confirm | | | | |
| | proposal | | | | | | |
| | prior to the | | | | | | |
| | meeting | | | | | | |
| 0123_pre4 | User1 to | 1 day before | Notify every | No | 1 day | None | No |
| | book a | the meeting | meeting | | | | |
| | conference | | invitee to | | | | |
| | room | | confirm | | | | |

The example prerequisite table in table 2 includes a prerequisite identifier linked to the meeting identifier of table 1, a prerequisite description, a prerequisite due date, a tracking mechanism indicator, a critical prerequisite identifier, a rescheduling minimum duration, a dependency indicator, and a completion status. Additional data can also be included as part of the prerequisite table. The prerequisite descriptions identify a responsible party and the action item or task to be completed by the responsible party. The prerequisite due date establishes when the prerequisite must be completed and can be specified in absolute or relative time. The tracking mechanism indicator indicates how the responsible party should be queried and notified about the prerequisite that the responsible party must complete. The critical prerequisite identifier identifies prerequisites that must be completed for the meeting to be held. Failure to meet the prerequisite due date of a critical prerequisite may result in cancellation and rescheduling of the meeting if no extra lead time is included in the scheduling. The rescheduling minimum duration indicates a minimum amount of time into the future a meeting must be rescheduled from the currently scheduled meeting date. The dependency indicator establishes dependency between prerequisites, for instance, prerequisite 0123_pre1 must be completed before 0123_pre3 can be performed. The completion status indicates whether a prerequisite has been completed.

Additional data tracked in the prerequisite table can include a preferred contact medium, such as e-mail, automated phone call, pager, text message, instant message, and the like. A notification period (e.g., daily reminder) and an amount of time before the due date to send notifications can also be configurable values. As a further option, an escalation request can be established to notify additional parties other than the responsible party of an impending or missed deadline, such as contacting a supervisor or team lead.

In exemplary embodiments, the scheduling tool 110 creates workflows 116 based on prerequisites and their dependencies. Workflows 116 may constructed based on the data in tables 1 and 2, and can also link to work products associated with meetings. The work products can be stored in work product storage 118 of the data storage system 108 for review and updates, and may include various types of files associated with meetings. For example, a proposal and comments regarding the proposal that is to be discussed at a meeting can be stored in the work product storage 118.

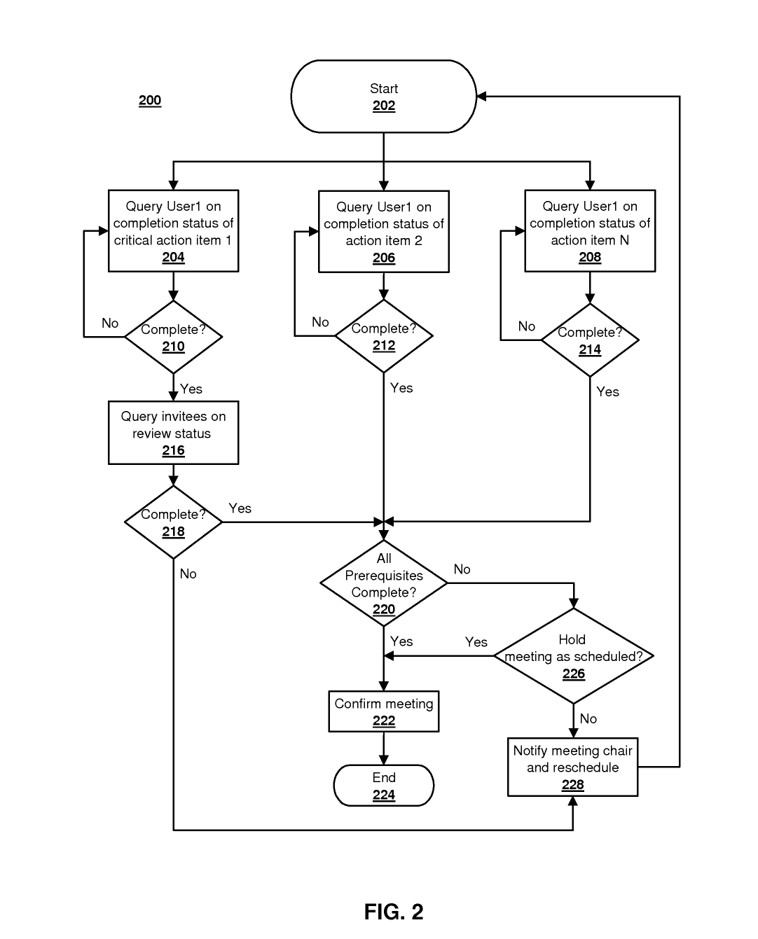

FIG. 2 depicts an example of a workflow 200 that can be stored in the workflows 116 and is constructed based on the example data in tables 1 and 2. At block 202, the workflow 200 starts with blocks 204, 206, and 208 triggered to query user1 on completion status of different action items as prerequisites to confirming scheduling of a meeting. The tracking mechanism defined in table 2 associated with each action item/prerequisite can be used to determine whom to query and how to query for status. Completion blocks 210, 212, and 214 are used to determine the completion status of the action items/prerequisites of blocks 204, 206, and 208 respectively. If completion block 210 determines that critical action item 1 of block 204 is complete, the flow advances to block 216; otherwise, flow returns to block 204. At block 216, invitees are queried on review status of a work product of the critical action item 1, such as reviewing the proposal in 0123_pre3 of table 2. Upon completion at completion blocks 212, 214, and 218, flow continues to completion block 220. If completion blocks 212 and 214 determine that respective action items in blocks 206 and 208 have not been completed, flow returns to the respective incomplete blocks 206 and/or 208. The tracking logic 112 of FIG. 1 can also monitor status relative to prerequisite due dates to determine when to take additional notification and/or rescheduling actions.

The completion block 220 verifies whether all prerequisites have been completed, and if so, the meeting is confirmed at block 222 and process 200 ends at block 224. If all of the prerequisites have not been completed, block 226 determines whether the meeting should still be held as scheduled. The determination at block 226 verifies whether all critical prerequisites have been completed and that the percentage of prerequisites competed meets or exceeds the threshold to confirm of table 1. If the verification is successful at block 226, the meeting is confirmed at block 222 and process 200 ends at block 224. Unsuccessful verification at block 226 results in notifying the meeting chair and rescheduling at block 228. After rescheduling at block 228, flow returns to start block 202.

Blocks 204, 206, 208, and 216 may map to prerequisites 0123_pre1, 0123_pre2, 0123_pre4, and 0123_pre3 of table 2 respectively. Since 0123_pre3 is dependent upon 0123_pre1, and 0123_pre3 is critical, a failure to complete at completion block 218 also results in notifying the meeting chair and rescheduling at block 228. As users respond to queries for status, the results can be recorded in the completion status fields of table 2 associated with the prerequisites. The completion blocks 210-214, 218, and 220 can use the completion status of table 2 for the status checks.

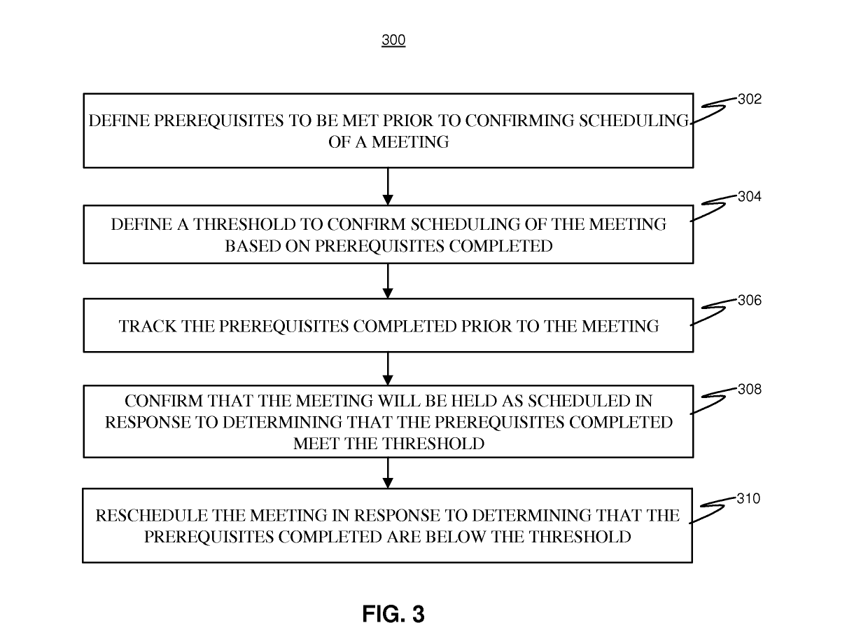

Turning now to FIG. 3, a process 300 for prerequisite-driven meeting scheduling is described in accordance with exemplary embodiments, and in reference to FIGS. 1 and 2. At block 302, the scheduling tool 110 defines prerequisites to be met prior to confirming scheduling of a meeting. The prerequisites can be stored in the scheduling database 114 and formatted as illustrated in tables 1 and 2. The scheduling tool 110 can establish dependency relationships between two or more of the prerequisites. The scheduling tool 110 may also create a workflow, such as workflow 200 of FIG. 2, that includes blocks of actions to be performed for the prerequisites, completion blocks to verify completion of the prerequisites, and sequential relationships between prerequisites with dependency relationships. The workflow 200 can be stored in workflows 116 of FIG. 1.

At block 304, the scheduling tool 110 defines a threshold to confirm scheduling of the meeting based on prerequisites completed. The threshold can be stored in the scheduling database 114. The threshold may be defined in terms of a percentage, ratio, or any numerical format (e.g., a count). The scheduling tool 110 can also configure one or more actions to be performed automatically in response to determining that prerequisites completed are below the threshold, such as automatically rescheduling the meeting. Automatically rescheduling the meeting may include adjusting reservations of resources for the meeting. The scheduling tool 110 may also configure one or more tracking mechanisms associated with the prerequisites, where the one or more tracking mechanisms define how the tracking logic 112 notifies responsible parties to confirm completion of the associated prerequisites.

At block 306, the tracking logic 112 of scheduling tool 110 executing on host system 102 tracks the prerequisites completed prior to the meeting. The tracking logic 112 can access the workflows 116 to determine a sequence of actions to be performed, such as the example workflow 200 of FIG. 2.

At block 308, the scheduling tool 110 confirms that the meeting will be held as scheduled in response to determining that the prerequisites completed meet the threshold. The scheduling tool 110 may also verify that all prerequisites identified as critical are completed as part of determining that the prerequisites completed meet the threshold.

At block 310, the scheduling tool 110 reschedules the meeting in response to determining that the prerequisites completed are below the threshold. The workflow associated with scheduling the meeting, such as workflow 200, may be updated in response to rescheduling the meeting. To adjust a scheduled meeting date, the scheduling tool 110 can determine a rescheduling minimum duration for an incomplete prerequisite and any prerequisites dependent upon the incomplete prerequisite. The scheduling tool 110 calculates a minimum duration adjustment as a sum of the rescheduling minimum durations of the incomplete prerequisite and any prerequisites dependent upon the incomplete prerequisite, and updates a scheduled meeting date according to the minimum duration adjustment. For instance, based on table 2, failure to complete prerequisite 0123_pre1, would result in a minimum duration adjustment of 6 business days, since 0123_pre3 depends on 0123_pre1, and the sum of the respective rescheduling minimum durations is 6 days. In addition, the scheduling tool 110 also takes into consideration if a meeting can be rescheduled or not. When a meeting chair schedules the meeting, the meeting chair may define if the meeting can be rescheduled, and if it can be rescheduled beyond a particular date. For example, if the meeting chair calls a meeting to discuss a response to a customer RFP (request for proposal) which has a response deadline, then any rescheduling of the meeting cannot go beyond the response deadline, or no less than a defined number of business days in the future. The scheduling tool 110 checks if it is feasible to reschedule. The scheduling tool 110 notifies the meeting chair if rescheduling of the meeting is not feasible, and the current schedule does not have enough completed prerequisites that satisfied the minimum threshold required prior to the meeting.

The capabilities of the present invention can be implemented in software, firmware, hardware or some combination thereof.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized to store instructions for execution of the scheduling tool 110 and tracking logic 112 of FIG. 1. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Moreover, the use of the terms first, second, etc. do not denote any order or importance, but rather the terms first, second, etc. are used to distinguish one element from another.

What is claimed is:

1. A method for prerequisite-driven meeting scheduling, comprising:
defining prerequisites to be met prior to confirming scheduling of a meeting;
defining a threshold to confirm scheduling of the meeting based on prerequisites completed;
tracking the prerequisites completed prior to the meeting, the tracking performed by tracking logic of a scheduling tool executing on a host system;
confirming that the meeting will be held as scheduled in response to determining that the prerequisites completed meet the threshold; and
rescheduling the meeting in response to determining that the prerequisites completed are below the threshold, the rescheduling performed by the scheduling tool executing on the host system.

2. The method of claim 1 further comprising:
verifying that all prerequisites identified as critical are completed as part of determining that the prerequisites completed meet the threshold.

3. The method of claim 1 further comprising:
establishing a dependency relationship between at least two of the prerequisites; and
creating a workflow comprising blocks of actions to be performed for the prerequisites, completion blocks to verify completion of the prerequisites, and a sequential relationship between the at least two of the prerequisites with the dependency relationship.

4. The method of claim 3 wherein the workflow is updated in response to rescheduling the meeting.

5. The method of claim 1 further comprising:
configuring one or more actions to be performed automatically by the scheduling tool in response to determining that the prerequisites completed are below the threshold, wherein the one or more actions include automatically rescheduling the meeting; and
configuring one or more tracking mechanisms associated with the prerequisites, the one or more tracking mechanisms defining how the tracking logic notifies responsible parties to confirm completion of the associated prerequisites.

6. The method of claim 5 wherein automatically rescheduling the meeting further comprises adjusting reservations of resources for the meeting.

7. The method of claim 6 wherein the automatically rescheduling the meeting further comprises determining a rescheduling minimum duration for an incomplete prerequisite and any prerequisites dependent upon the incomplete prerequisite, calculating a minimum duration adjustment as a sum of the rescheduling minimum durations of the incomplete prerequisite and the any prerequisites dependent upon the incomplete prerequisite, and updating a scheduled meeting date according to the minimum duration adjustment.

8. A system for prerequisite-driven meeting scheduling, comprising:
a scheduling database; and
a host system in communication with the scheduling database and configured to perform:
defining prerequisites to be met prior to confirming scheduling of a meeting;
storing the prerequisites in the scheduling database;
defining a threshold to confirm scheduling of the meeting based on prerequisites completed;
tracking the prerequisites completed prior to the meeting;
confirming that the meeting will be held as scheduled in response to determining that the prerequisites completed meet the threshold; and
rescheduling the meeting in response to determining that the prerequisites completed are below the threshold.

9. The system of claim 8 wherein the host system is further configured to perform:
verifying that all prerequisites identified as critical are completed as part of determining that the prerequisites completed meet the threshold.

10. The system of claim 8 wherein the host system is further configured to perform:
establishing a dependency relationship between at least two of the prerequisites; and
creating a workflow comprising blocks of actions to be performed for the prerequisites, completion blocks to verify completion of the prerequisites, and a sequential relationship between the at least two of the prerequisites with the dependency relationship.

11. The system of claim 10 wherein the workflow is updated in response to rescheduling the meeting.

12. The system of claim 8 wherein the host system is further configured to perform:
configuring one or more actions to be performed automatically in response to determining that the prerequisites completed are below the threshold, wherein the one or more actions include automatically rescheduling the meeting; and
configuring one or more tracking mechanisms associated with the prerequisites, the one or more tracking mechanisms defining how to notify responsible parties to confirm completion of the associated prerequisites.

13. The system of claim 12 wherein automatically rescheduling the meeting further comprises:
adjusting reservations of resources for the meeting; and
determining a rescheduling minimum duration for an incomplete prerequisite and any prerequisites dependent upon the incomplete prerequisite, calculating a minimum duration adjustment as a sum of the rescheduling minimum durations of the incomplete prerequisite and the any prerequisites dependent upon the incomplete prerequisite, and updating a scheduled meeting date according to the minimum duration adjustment.

14. A computer program product for prerequisite-driven meeting scheduling, the computer program product comprising:
a computer readable storage medium readable by a processing circuit and storing instructions for execution by the processing circuit for implementing a method, the method comprising:
defining prerequisites to be met prior to confirming scheduling of a meeting;
defining a threshold to confirm scheduling of the meeting based on prerequisites completed;
tracking the prerequisites completed prior to the meeting;
confirming that the meeting will be held as scheduled in response to determining that the prerequisites completed meet the threshold; and
rescheduling the meeting in response to determining that the prerequisites completed are below the threshold.

15. The computer program product of claim 14 wherein the method further comprises:
verifying that all prerequisites identified as critical are completed as part of determining that the prerequisites completed meet the threshold.

16. The computer program product of claim 14 wherein the method further comprises:
establishing a dependency relationship between at least two of the prerequisites; and
creating a workflow comprising blocks of actions to be performed for the prerequisites, completion blocks to verify completion of the prerequisites, and a sequential relationship between the at least two of the prerequisites with the dependency relationship.

17. The computer program product of claim 16 wherein the workflow is updated in response to rescheduling the meeting.

18. The computer program product of claim 14 wherein the method further comprises:
configuring one or more actions to be performed automatically in response to determining that the prerequisites completed are below the threshold, wherein the one or more actions include automatically rescheduling the meeting; and
configuring one or more tracking mechanisms associated with the prerequisites, the one or more tracking mechanisms defining how to notify responsible parties to confirm completion of the associated prerequisites.

19. The computer program product of claim 18 wherein automatically rescheduling the meeting further comprises adjusting reservations of resources for the meeting.

20. The computer program product of claim 19 wherein the automatically rescheduling the meeting further comprises determining a rescheduling minimum duration for an incomplete prerequisite and any prerequisites dependent upon the incomplete prerequisite, calculating a minimum duration adjustment as a sum of the rescheduling minimum durations of the incomplete prerequisite and the any prerequisites dependent upon the incomplete prerequisite, and updating a scheduled meeting date according to the minimum duration adjustment.
